(19) United States
(12) Patent Application Publication
(10) Pub. No.: US 2026/0177486 A1
(43) Pub. Date: Jun. 25, 2026

(54) UV LIGHT VIEWING APPARATUS FACILITATING SAMPLE TESTING

(71) Applicant: IDEXX Laboratories, Inc., Westbrook, ME (US)

(72) Inventors: Daniel Broder, Westbrook, ME (US); Eric Marcotte, Westbrook, ME (US); Emily Frawley, Westbrook, ME (US); Paul Brinnel, Westbrook, ME (US)

(21) Appl. No.: 19/424,210

(22) Filed: Dec. 18, 2025

Related U.S. Application Data
(60) Provisional application No. 63/736,630, filed on Dec. 20, 2024.

(51) Int. Cl. G01N 21/64

(52) U.S. Cl. CPC G01N 21/6447; G01N 21/645; G01N 2021/6471; G01N 2201/062; G01N 2201/064

(57) ABSTRACT

An ultraviolet (UV) light viewing apparatus includes a housing defining an interior volume enclosed along a rear end of the housing and portions of sides of the housing to define an access opening extending along a front end of the housing and portions of the sides of the housing. At least one UV light source is configured to illuminate the interior volume. An opening through a roof of the housing enables visualization into the interior volume. A curtain engages the housing and covers at least a portion of the access opening. The curtain includes a plurality of flexible, vertically-extending curtain strips that are movable to enable access to the interior volume. Alternatively or additionally, the curtain includes a front portion extending along the front end of the housing and side portions that extend along portions of the sides of the housing to substantially cover the access opening.

### CROSS REFERENCE TO RELATED APPLICATIONS

This application claims priority to U.S. Provisional Application No. 63/736,630 filed December 20, 2024 which is incorporated herein by reference in its entirety.

### TECHNICAL FIELD

The present disclosure relates to sample testing and, more particularly, to an ultraviolet (UV) light viewing apparatus to facilitate sample testing.

### BACKGROUND

Fluorescence is utilized in sample testing to, for example, detect bacteria in a test sample. In particular, fluorescence detection may be utilized to test a water sample for E. coli, enterococci, Legionella, and/or coliforms. Fluorescence is also used for testing other samples and/or for other bacteria.

Fluorescence testing may involve illuminating a sample with ultraviolet (UV) light and observing the sample for the presence/absence of a bacteria in the test sample and/or to quantify an amount of the bacteria in the test sample. A darkroom environment may be utilized to increase contrast, thus facilitating the identification of the presence/absence of fluorescence of the test sample and/or the quantification of fluorescence of the test sample.

### SUMMARY

Terms including “generally,” “about,” “substantially,” and the like, as utilized herein, are meant to encompass variations, e.g., manufacturing tolerances, material tolerances, use and environmental tolerances, measurement variations, design variations, and/or other tolerances and variations, up to and including plus or minus 10 percent. Further, to the extent consistent, any or all of the aspects detailed herein may be used in conjunction with any or all of the other aspects detailed herein.

In accordance with aspects of the present disclosure, an ultraviolet (UV) light viewing apparatus is provided including a housing configured to block ambient and UV light. The housing has a floor, a roof, and a sidewall cooperating to define an interior sample test-receiving volume enclosed along a rear end of the housing and portions of opposing first and second sides of the

housing to thereby define an access opening providing access to the interior sample test-receiving volume that extends along a front end of the housing and portions of opposing first and second sides of the housing. At least one UV light source is configured to illuminate the interior sample test-receiving volume. An opening is defined within the roof of the housing to enable visualization into the interior sample test-receiving volume. A curtain configured to block ambient and UV light is engaged with the housing and covers at least a portion of the access opening.

In aspects, the curtain includes a plurality of flexible, vertically-extending curtain strips that are movable relative to one another to enable access to the interior sample test-receiving volume through the access opening. In alternative or additional aspects, the curtain includes a front portion covering the front end of the housing and first and second side portions covering the portions of the first and second sides of the housing not occupied by the sidewall.

In an aspect of the present disclosure, the curtain is removably engagable with the housing. In such aspects, the curtain may include a frame and a curtain body supported by and depending from the frame, wherein the frame of the curtain is releasably magnetically engagable with the housing.

In another aspect of the present disclosure, at least a portion of the curtain is made of neoprene.

In still another aspect of the present disclosure, the at least one UV light source includes at least one array of LED excitation lights mounted on an interior surface of the housing. In such aspects, the at least one array of LED excitation lights may include a first array of LED excitation lights mounted along the first side of the housing, a second array of LED excitation lights mounted along the second side of the housing, a third array of LED excitation lights mounted along the rear end of the housing, and/or a fourth array of LED excitation lights mounted along the front end of the housing.

In yet another aspect of the present disclosure, an eyepiece disposed over the opening in the roof of the housing. Additionally or alternatively, a transparent, UV-A filtering window extends across the opening in the roof.

In still yet another aspect of the present disclosure, the housing includes a frame and a cover disposed over the frame.

### BRIEF DESCRIPTION OF THE DRAWINGS

Various aspects and features of the present disclosure are described hereinbelow with reference to the drawing figures, wherein:

FIG. 1 is a perspective view of an ultraviolet (UV) light viewing apparatus provided in accordance with aspects of the present disclosure;

FIG. 2 is a front view of the UV light viewing apparatus of FIG. 1;

FIG. 3 is a perspective, partial transparent view of the UV light viewing apparatus of FIG. 1;

FIG. 4 is an exploded, perspective view of the UV light viewing apparatus of FIG. 1;

FIG. 5 is an enlarged, exploded, perspective view of the UV light viewing apparatus of FIG. 1;

FIG. 6 is an enlarged, exploded, perspective view of a cover and viewing assembly of the UV light viewing apparatus of FIG. 1;

FIG. 7A is an enlarged, perspective view of a curtain assembly of the UV light viewing apparatus of FIG. 1;

FIG. 7B is an exploded, perspective view of the curtain assembly of FIG. 7A; and

FIG. 8 is an enlarged, perspective view of a portion of the UV light viewing apparatus of FIG. 1 illustrating a sample under test observable through a viewing assembly of the UV light viewing apparatus of FIG. 1.

### DETAILED DESCRIPTION

The present disclosure relates to an ultraviolet (UV) light viewing apparatus, shown generally identified by reference numeral 10. UV light viewing apparatus 10 establishes a darkroom environment to facilitate UV-light based sample testing, e.g., fluorescence detection of a sample illuminated with UV light.

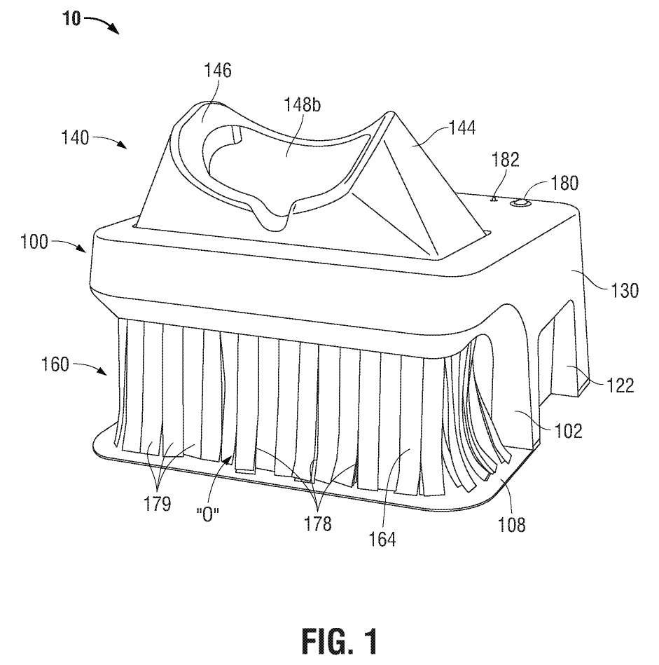

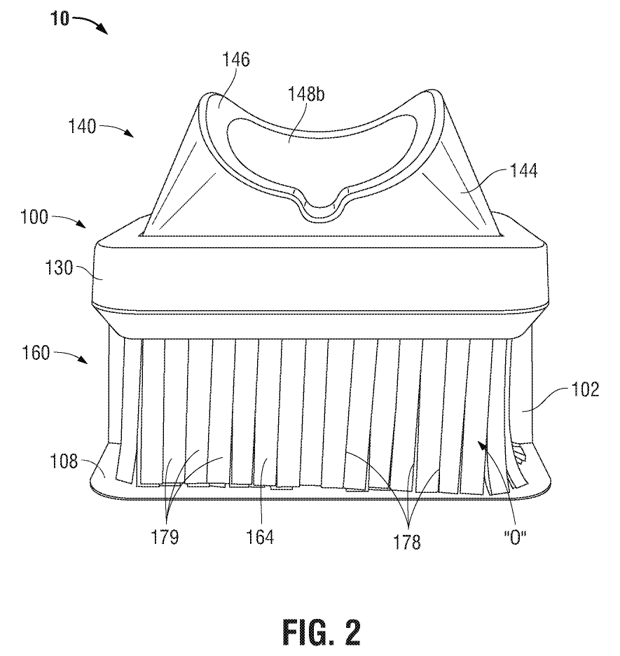

Turning to FIGS. 1-4, UV light viewing apparatus 10 generally includes a housing 100, a viewing assembly 140, a plurality of UV light sources 150, and a curtain assembly 160. Housing 100 is formed from a substantially rigid material and includes a frame 102 and a cover 130 disposed about and engaging frame 102 to define an interior sample test-receiving volume “V”. Housing 100 is configured to block ambient and ultraviolet light into and from the interior sample test-receiving volume “V”. Viewing assembly 140 enables a user to visualize the interior sample test-receiving volume “V” without compromising the darkroom environment therein. The plurality of UV light sources 150 is configured to illuminate sample test(s) disposed within the interior sample test-receiving volume “V”. Curtain assembly 160 is configured to block ambient and ultraviolet light into and from the interior sample test-receiving volume “V” and cooperates with housing 100 such that the interior sample test-receiving volume “V” defines a darkroom environment to facilitate, for example, fluorescence detection in response to illumination of the sample test(s) with UV light from UV light sources 150 while also facilitating insertion, removal, and repositioning of the sample test(s) within the interior sample test-receiving volume “V” without compromising the darkroom environment.

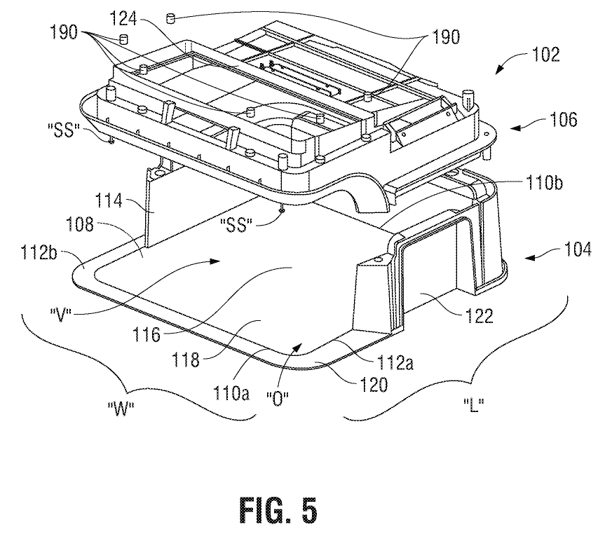

With additional reference to FIG. 5, frame 102 of UV light viewing apparatus 10 includes a frame base 104 and a frame top 106. Frame base 104 and frame top 106 may be formed from a polymeric material and may define a dark color such as black. Frame base 104 includes a substantially planar floor 108 defining a generally rectangular configuration having front and rear ends 110a, 110b, respectively, and opposing sides 112a, 112b. A length “L” of floor 108, defining the length of UV light viewing apparatus 10, extends between respective front and rear ends 110a, 110b of floor 108, and a width “W” of floor 108, defining the width of UV light viewing apparatus 10, extends perpendicularly relative to length “L” between opposing sides 112a, 112b of floor 108. Floor 108 is configured to be supported on a horizontal surface, e.g., benchtop, tabletop, etc., in substantially horizontal orientation.

In aspects, floor 108 is dimensioned to enable positioning of two sample test trays thereon each having dimensions of at least about 11 inches by about 6 inches. These sample test trays include, for example, the Quanti-Tray^{®}, Quanti-Tray^{®}/2000, and Quanti-Tray^{®}/Legiolert^{®} sample test trays available from IDEXX Laboratories, Inc. of Westbrook, Maine, USA, although other sample test trays are also contemplated for use with UV light viewing apparatus 10.

Frame base 104 further includes a sidewall 114 extending vertically from, and in substantially perpendicular orientation relative to, floor 108. Sidewall 114 extends along rear end 110b of floor 108, the entire width “W” of floor 108, and from rear end 110b of floor 108 along a portion of each opposing side 112a, 112b of floor 108 a distance less than the entire length “L” of floor 108. Thus, floor 108 includes a rear portion 116 surrounded on three sides by sidewall 114 and a front portion 118 open on three sides. In aspects, rear portion 116 defines a length of from about 50% to about 80% of the length “L” of floor 108 and, thus, front portion 118 defines a length of from about 20% to about 50% of the length “L” of floor 108, although other configurations are also contemplated.

In aspects, floor 108 includes a raised lip 120 defined along the three open sides of front portion 118 of floor 108. In additional or alternative aspects, sidewall 114 of frame base 104 includes an outwardly-facing recess 122 defined within the opposing portions of sidewall 114 that extend along opposing sides 112a, 112b of floor 108. Recesses 122 provide a grasping area to facilitate manipulating and/or maneuvering UV light viewing apparatus 10.

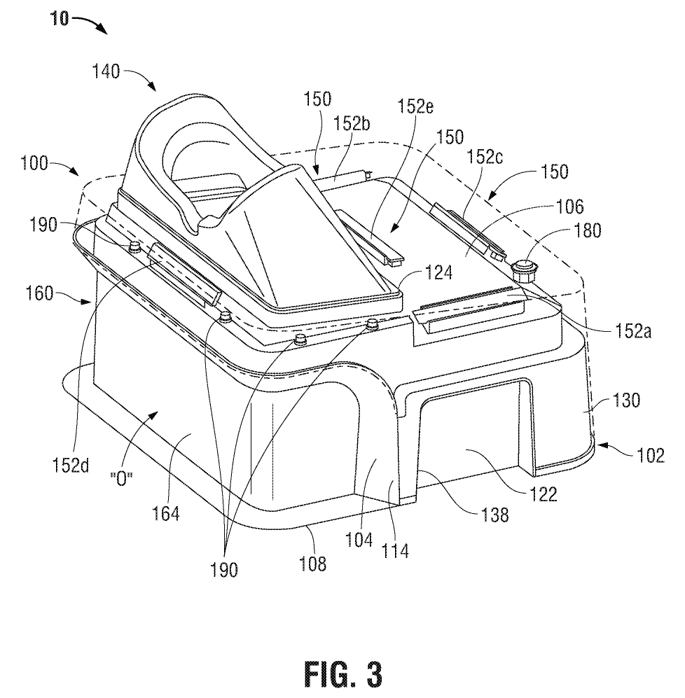

Referring to FIGS. 3-5, frame top 106 of frame 102 engages or is formed with frame base 104 of frame 102 to define the roof of housing 100 and, more specifically, cooperates with sidewall 114 and floor 108 to define the interior sample test-receiving volume “V” of housing 100 of UV light viewing apparatus 10. Frame top 106 may be engaged with sidewall 114 via screws “S” (as shown), snap-fit engagement, etc., or may be integrally formed with frame base 104 as a single component, e.g., via molding. Frame top 106, in aspects, defines length and width dimensions substantially equal to the length “L” and width “W” of floor 108, respectively, such that frame top 106 defines a roof over substantially all of floor 108. As such, rear portion 116 of floor 108 is surrounded on three sides by sidewall 114 and covered by frame top 106 while front portion 118 of floor 108 is open on three sides with frame top 106 defining an overhang covering front portion 118 of floor 108.

Frame top 106 of frame 102 further defines an opening 124 therethrough that is configured to receive viewing assembly 140 to enable visualization into the interior sample test-receiving volume “V” of housing 100 of UV light viewing apparatus 10. A power button 180, e.g., enabling selective activation (e.g., ON) and deactivation (e.g., OFF) of the plurality of UV light sources 150 is mounted on frame top 106. Power button 180 may include an integrated indicator light or a separate indicator light 182 may be provided and likewise mounted on frame top 106 to indicate the condition of UV light viewing apparatus 10, e.g., whether UV light viewing apparatus 10 is ON (indicator light 182 illuminated or illuminated in a first color) or OFF (indicator light 182 unilluminated or illuminated in a second, different color) and/or whether an error condition is present. Power button 180, indicator light 182 (in aspects where provided), and UV light sources 150 are electrically connected to a cable (not shown) configured to connect UV light viewing apparatus 10 to a power supply, e.g., a main power supply outlet, although battery- powered configurations including a battery disposed on or within housing 100 are also contemplated.

Referring still to FIGS. 3-5, frame top 106 of frame 102 also support a plurality of magnets 190, e.g., neodymium or other suitable magnets. Magnets 190 may be seated within recesses defined within frame top 106, e.g., within the upper surface thereof, although other configurations are also contemplated. Further, although shown as cylindrical magnets 190 other suitable magnet configurations are also contemplated. The plurality of magnets 190 may include and be arranged with at least one magnet 190 and, in aspects, a plurality of spaced-apart magnets 190 disposed along the first side of the portion of frame top 106 that overhangs front portion 118 of floor 108; at least one magnet 190 and, in aspects, a plurality of spaced-apart magnets 190 disposed along the second, opposite side of the portion of frame top 106 that overhangs front portion 118 of floor 108; and/or at least one magnet 190 and, in aspects, a plurality of spaced-apart magnets 190 disposed along the front end of frame top 106. As detailed below, the plurality of magnets 190 enable releasable magnetic engagement of curtain assembly 160 with housing 100.

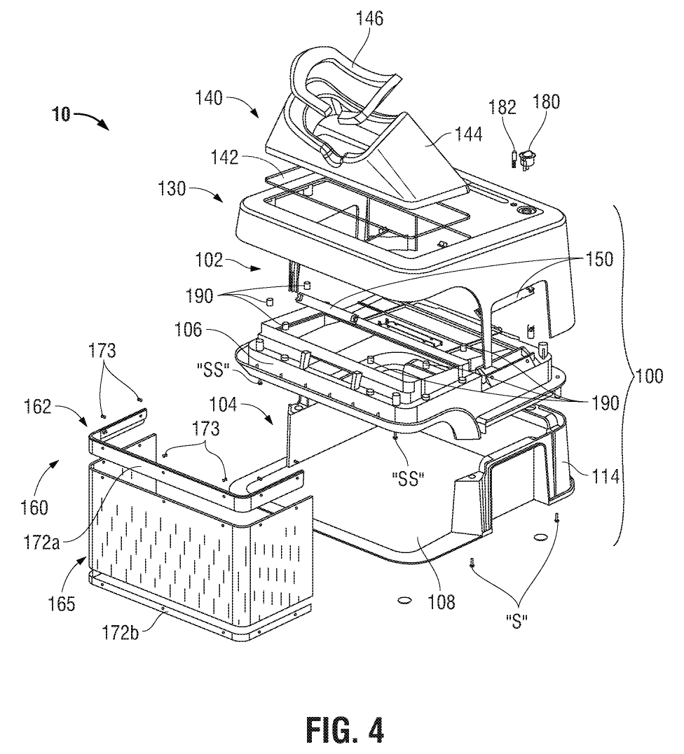

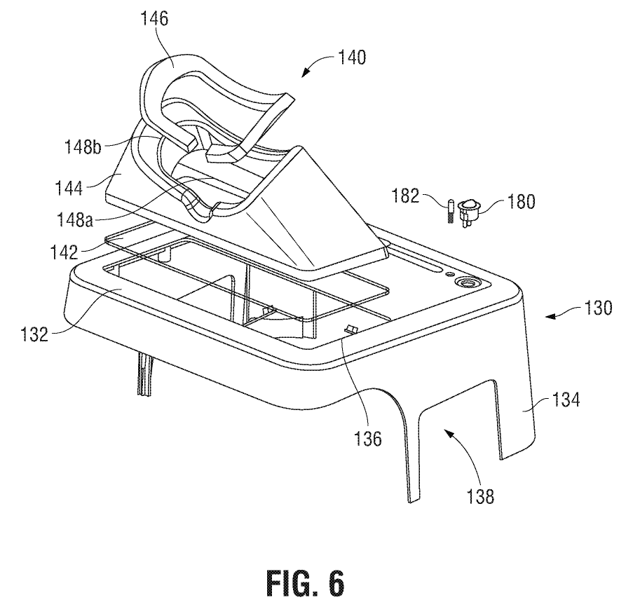

Turning to FIGS. 1-4 and 6, cover 130 of UV light viewing apparatus 10 is configured to fit over frame 102 and cooperate therewith to define housing 100 of UV light viewing apparatus 10. Cover 130 may be secured about frame 102 via screws “SS” (as shown in FIGS. 4 and 5), snap-fit engagement, or in any other suitable manner, and may be formed integrally, e.g., via molding, from a polymeric or via any other suitable method and/or material.

Cover 130, more specifically, includes a top portion 132 that is configured for positioning about frame top 106 and a sidewall portion 134 that is configured for positioning about sidewall 114 of frame base 104. Top portion 132 of cover 130 substantially approximates the configuration of frame top 106 and includes an opening 136 configured to align with opening 124 of frame top 106, while sidewall portion 134 of cover 130 substantially approximates the configuration of sidewall 114 of frame base 104 and includes slots 138 configured to align with recesses 122 of sidewall 114 of frame base 104. Further, power button 180 and indicator light 182 extend through top portion 132 of cover 130 to enable access to power button 180 from an exterior of UV light viewing apparatus 10 and to enable visualization of the state of indicator light 182 from an exterior of UV light viewing apparatus 10, respectively.

With cover 130 substantially approximating the configurations of frame top 106 and sidewall 114 of frame base 104 and defining opening 136 and slots 138, as detailed above, cover 130 does not interfere with recesses 122 of frame 102 or viewing assembly 140. Further, cover 130 does not interfere with the three open sides of front portion 118 of floor 108 of frame base 104 of frame 102. As such, an access opening “O” into the interior sample test-receiving volume “V” of housing 100 of UV light viewing apparatus 10 extending across the front end of housing 100, around the front end corners of housing 110, and along portions of the opposing sides of housing 100, is defined.

Continuing with reference to FIGS. 1-4 and 6, viewing assembly 140 includes a window 142, an eyepiece housing 144, and an eyepiece cushion 146. Window 142 is formed from a transparent material and, in aspects, is formed from a transparent, UV-A filtering material, e.g., a UV-A filtering clear acrylic. Window 142 is configured to be seated within opening 124 of frame top 106 of frame 102 to thereby close opening 124 while still permitting visualization therethrough and into the interior sample test-receiving volume “V” of housing 100 of UV light viewing apparatus 10. Eyepiece housing 144 includes an open lower end 148a that surrounds window 142. Eyepiece housing 144 extends from open lower end 148a to an open upper viewing end 148b. Eyepiece housing 144 may define a funnel-shaped configuration wherein eyepiece housing 144 widens in at least one dimension, e.g., the width dimension, from open upper viewing end 148b to open lower end 148a. At least one other dimension, e.g., the length dimension, may remain substantially constant from open upper viewing end 148b to open lower end 148a.

Eyepiece cushion 146 surrounds open upper viewing end 148b of eyepiece housing 144 and defines a compressible and/or flexible configuration, e.g., via formation of eyepiece cushion 146 from a flexible polymeric material or compressible foam material, to provide a comfortable interface for a user to rest their face on while viewing the interior sample test-receiving volume “V” of housing 100 of UV light viewing apparatus 10 through eyepiece housing 144 and window 142. This compressibility and/or flexibility of eyepiece cushion 146 together with the contoured shape of open upper viewing end 148b of eyepiece housing 144 facilitates a substantially flush fit against a user’s face when the user is viewing the interior sample test-receiving volume “V” of housing 100, thereby blocking ambient light from entering the interior sample test-receiving volume “V” of housing 100 via open upper viewing end 148b of eyepiece housing 144. In aspects, eyepiece housing 144, including eyepiece cushion 146, is removable from housing 100 of UV light viewing apparatus 10, e.g., to enable cleaning. Window 142 may additionally or alternatively be removable from housing 100, e.g., to enable cleaning.

With reference to FIGS. 3 and 4, the plurality of UV light sources 150 are mounted on the interior surface of frame top 106 of frame 102 of housing 100 to illuminate the interior sample test-receiving volume “V” of housing 100 when activated. UV light source 150 may be configured as LED strips defining elongated configurations, although other configurations are also contemplated. Each LED strip may be a printed circuit board (PCB) including an array of a plurality of LED excitation lights, e.g., six LED’s, each configured to emit UV light. In aspects, the emitted UV light defines a wavelength of about 365 nm. In aspects, at least four LED strip UV light sources 150 are provided. In other aspects, at least five LED strip UV light sources 150 are provided.

The LED strip UV light sources 150 may be arranged with a first light source 152a extending along a portion of the first side of frame top 106, a second light source 152b extending along the second, opposite side of frame top 106, a third light source 152c extending along the rear end of frame top 106, and a fourth light source 152d extending along the opposite, front end of frame top 106. Where a fifth light source 152e is provided, the fifth light source 152e may extend along a width dimension of opening 124 of frame top 106 disposed between opening 124 and the rear end of frame top 106. This arrangement of at least four (or at least five) UV light sources 150 provides UV illumination of substantially all of floor 108, such that substantially all of the sample test(s) is illuminated and, thus, fluorescence detection of substantially all of the sample can be achieved with minimal to no repositioning required.

The UV light sources 150 are independently connected or connected in parallel to the cable (not shown) such if one UV light source 150 malfunctions, the remaining UV light sources 150 remain functional. Further, in addition or as an alternative to indicator light 182 indicating an ON/OFF condition of the UV light viewing apparatus 10, indicator light 182 may be illuminated, e.g., with a different color, different pattern (flashing light, for example), etc., to indicate that one or more of UV light source 150 has malfunctioned and is thus not operational.

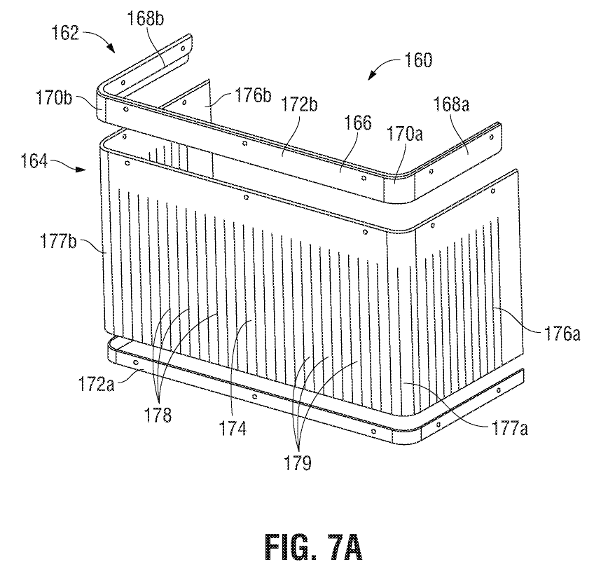

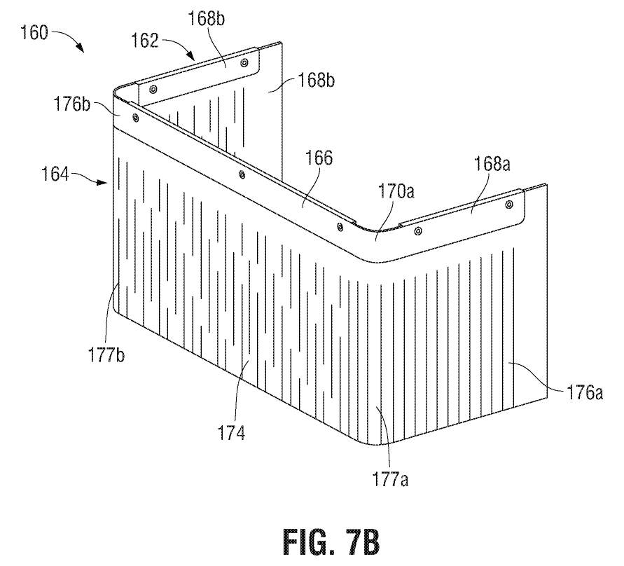

Turning to FIGS. 7A and 7B, in conjunction with FIGS. 1, 2, and 4, curtain assembly 160 includes a frame 162 and a curtain body 164. Frame 162 is at least partially formed from a magnetic material and devices a generally C-shaped configuration having a substantially linear front segment 166, first and second substantially linear side segments 168a, 168b, respectively, extending substantially perpendicularly from opposing sides of front segment 166, and first and second corner segments 170a, 170b, e.g., rounded corners, interconnecting first side segment 168a with the first side of front segment 166 and second side segment 168b with the second side of front segment 166, respectively. Frame 162 is configured to support curtain body 164 with curtain body 164 depending from frame 162. Frame 162 may include, in aspects, inner and outer frame portions 172a, 172b capturing curtain body 164 therebetween. A plurality of pins 173 may extend through aligned apertures defined through inner and outer frame portions 172a, 172b and as well as curtain body 164 to secure curtain body 164 and frame 162 to one another with curtain body 164 depending from frame 162.

With curtain body 164 supported by and depending from frame 162, curtain body 164 substantially conforms to the shape of frame 162, such that curtain body 164 defines a substantially planar front section 174, first and second substantially planar side sections 176a, 176b, respectively, extending substantially perpendicularly from opposing sides of front section 166, and first and second corner sections 177a, 177b, e.g., curved corner sections, interconnecting first side section 176a with the first side of front section 174 and second side section 176b with the second side of front section 174. Curtain body 164 may be formed from a sheet of flexible, polymeric material such as, for example, neoprene, although other materials are also contemplated.

Curtain body 164 defines a plurality of vertical slits 178 spaced-apart across an entire width of curtain body 164, e.g., from a first side edge of first side section 176a, along first side section 176a, first corner section 177a, front section 174, second corner section 177b, and second side section 176b to a second side edge of second side section 176b. Vertical slits 178 may be equally spaced or may define variable spacing therebetween such that vertical slits 178 are spaced differently across one or more portions of curtain body 164 compared to one or more other portions of curtain body 164. Vertical slits 178 extend from a bottom edge of curtain body 164 upwardly towards a top edge of curtain body 164 but terminate prior to reaching the top edge of curtain body 164 such that curtain body 164 remains a single, integral piece of material. In aspects, vertical slits 178 extend from the bottom edge of curtain body 164 from about 60% to about 90% of a height of curtain body 164, although other configurations are also contemplated.

Due to the vertical slits 178 defined through curtain body 164, a plurality of curtain strips 179 of curtain body 164 are formed. Curtain strips 179 are independently movable relative to one another. In an at-rest configuration, curtain strips 179 cooperate to define a wall that substantially blocks transmission of ambient light as well as UV-light therethrough. However, curtain strips 179 may be easily manipulated to enable insertion and/or removal of a sample test and/or a user’s hand(s) through the wall defined by curtain strips 179 of curtain body 164.

Referring to FIGS. 1-4, curtain assembly 160 is configured for releasable magnetic engagement with housing 100 of UV light viewing apparatus 10. More specifically, curtain assembly 160 is configured for insertion into access opening “O” of housing 100 until front segment 166 of frame 162 of curtain assembly 160 substantially aligns with and is approximated relative to the front end of frame top 106 of frame 102 of housing 100 and first and second side segments 168a, 168b of frame 162 of curtain assembly 160 substantially align with and are approximated relative to the respective opposing sides of frame top 106 of frame 102 of housing 100, whereby the magnets 190 magnetically engage frame 162 of curtain assembly 160 to retain curtain assembly 160 in position relative to housing 100.

With curtain assembly 160 magnetically engaged with housing 100, curtain strips 179 of curtain body 164 enclose access opening “O” of housing 100. That is, curtain strips 179 enclose the three open sides of front portion 118 of floor 108 of frame base 104 of frame 102, thereby enclosing the interior sample test-receiving volume “V” of housing 100 of UV light viewing apparatus 10. However, as noted above, curtain strips 179 may be easily displaced to enable insertion and/or removal of a sample test and/or a user’s hand through curtain body 164 and into the interior sample test-receiving volume “V”. Further, due to the configuration of access opening “O” of housing 100 and the corresponding configuration of curtain assembly 160, a sample test and/or a user’s hand(s) may be inserted through the front of housing 100 and/or through either side of housing 100. As such, the range of approach angles through access opening “O” and into the interior sample test-receiving volume “V” is up to and including 180 degrees (and, in aspects, greater than 180 degrees), thus facilitating insertion/removal, positioning, and manipulation of one or more sample tests into the interior sample test-receiving volume “V”.

Once the one or more sample tests are positioned as desired within the interior sample test-receiving volume “V”, and with or without the user’s hands removed, UV light viewing apparatus 10 may be activated whereby curtain assembly 160 substantially inhibits ambient light from entering the interior sample test-receiving volume “V” and UV light form escaping the interior sample test-receiving volume “V”. That is, curtain strips 179 enclose the front and sides of access opening “O” entirely or around any objects inserted therethrough such as the user’s hand(s), thereby creating a darkroom environment within the interior sample test-receiving volume “V” to facilitate detection of fluorescence of the sample under test.

Once testing is complete, or otherwise in order to facilitate cleaning of UV light viewing apparatus 10, curtain assembly 160 may be removed from engagement with housing 100 by applying sufficient pulling force to overcome the magnetic engagement of curtain assembly 160 with housing 100. Once curtain assembly 160 is removed, curtain assembly 160 and/or the interior sample test-receiving volume “V” may be cleaned prior to reinstallation of curtain assembly 160 for subsequent testing.

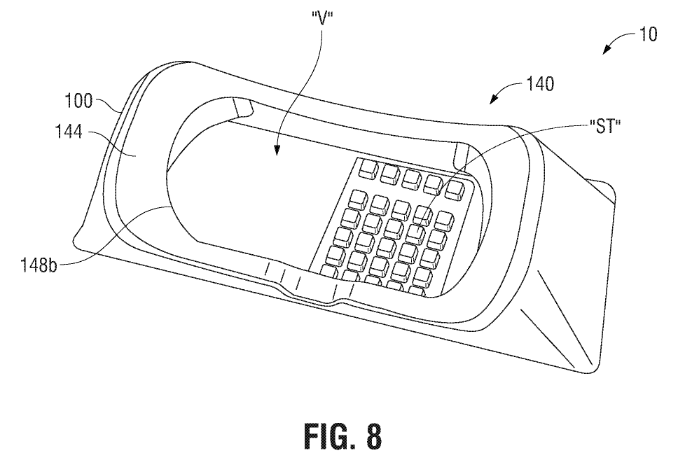

FIG. 8 illustrates a sample test “ST” disposed within the darkroom environment of the interior sample test-receiving volume “V” of housing 100 of UV light viewing apparatus 10 with UV light viewing apparatus 10 activated. By the above-detailed configuration of UV light viewing apparatus 10, as shown in FIG. 8, fluorescence of sample wells of the sample test “ST” can be readily detected by viewing the sample test “ST” through viewing assembly 140.

Aspects of this disclosure may be further described by reference to the following numbered paragraphs:

1. An ultraviolet (UV) light viewing apparatus, comprising: a housing configured to block ambient and UV light, the housing having a floor, a roof, and a sidewall cooperating to define an interior sample test-receiving volume enclosed along a rear end of the housing and portions of opposing first and second sides of the housing to thereby define an access opening providing access to the interior sample test-receiving volume that extends along a front end of the housing and portions of opposing first and second sides of the housing; at least one UV light source configured to illuminate the interior sample test-receiving volume; an opening defined within the roof of the housing, the opening configured to enable visualization into the interior sample test-receiving volume; and a curtain configured to block ambient and UV light, the curtain engaged with the housing and covering at least a portion of the access opening, wherein: the curtain includes a plurality of flexible, vertically-extending curtain strips that are movable relative to one another to enable access to the interior sample test-receiving volume through the access opening; and/or the curtain includes a front portion extending along the front end of the housing and first and second side portions that extend along respective first and second portions of the opposing first and second sides of the housing not occupied by the sidewall such that the curtain substantially covers the access opening.

2. The UV light viewing apparatus according to paragraph 1, wherein the curtain is removably engagable with the housing.

3. The UV light viewing apparatus according to paragraph 2, wherein the curtain includes a frame and a curtain body supported by and depending from the frame, the frame of the curtain releasably magnetically engagable with the housing.

4. The UV light viewing apparatus according to any one of paragraphs 1-3, wherein each curtain strip of the plurality of flexible, vertically-extending curtain strips is made of neoprene.

5. The UV light viewing apparatus according to any one of paragraphs 1-4, wherein the at least one UV light source includes at least one array of LED excitation lights mounted on an interior surface of the housing.

6. The UV light viewing apparatus according to paragraph 5, wherein the at least one array of LED excitation lights mounted on the interior surface of the housing includes a first array of LED excitation lights mounted along the first side of the housing, a second array of LED excitation lights mounted along the second side of the housing, a third array of LED excitation lights mounted along the rear end of the housing, and a fourth array of LED excitation lights mounted along the front end of the housing.

7. The UV light viewing apparatus according to any one of paragraphs 1-6, further comprising an eyepiece disposed over the opening in the roof of the housing.

8. The UV light viewing apparatus according to any one of paragraphs 1-7, further comprising a transparent, UV-A filtering window extending across the opening in the roof.

9. The UV light viewing apparatus according to any one of paragraphs1-8, wherein the housing includes a frame and a cover disposed over the frame.

While several aspects and features of the disclosure are detailed above and shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed:

1. An ultraviolet (UV) light viewing apparatus, comprising:
a housing configured to block ambient and UV light, the housing having a floor, a roof, and a sidewall cooperating to define an interior sample test-receiving volume enclosed along a rear end of the housing and portions of opposing first and second sides of the housing to thereby define an access opening providing access to the interior sample test-receiving volume that extends along a front end of the housing and portions of opposing first and second sides of the housing;
at least one UV light source configured to illuminate the interior sample test-receiving volume;
an opening defined within the roof of the housing, the opening configured to enable visualization into the interior sample test-receiving volume; and
a curtain configured to block ambient and UV light, the curtain engaged with the housing and covering at least a portion of the access opening, the curtain including a plurality of flexible, vertically-extending curtain strips that are movable relative to one another to enable access to the interior sample test-receiving volume through the access opening.

2. The UV light viewing apparatus according to claim 1, wherein the curtain includes a front portion covering the front end of the housing and first and second side portions covering the portions of the first and second sides of the housing not occupied by the sidewall.

3. The UV light viewing apparatus according to claim 1, wherein the curtain is removably engagable with the housing.

4. The UV light viewing apparatus according to claim 3, wherein the curtain includes a frame and a curtain body supported by and depending from the frame, the frame of the curtain releasably magnetically engagable with the housing.

5. The UV light viewing apparatus according to claim 1, wherein each curtain strip of the plurality of flexible, vertically-extending curtain strips is made of neoprene.

6. The UV light viewing apparatus according to claim 1, wherein the at least one UV light source includes at least one array of LED excitation lights mounted on an interior surface of the housing.

7. The UV light viewing apparatus according to claim 6, wherein the at least one array of LED excitation lights mounted on the interior surface of the housing includes a first array of LED excitation lights mounted along the first side of the housing, a second array of LED excitation lights mounted along the second side of the housing, a third array of LED excitation lights mounted along the rear end of the housing, and a fourth array of LED excitation lights mounted along the front end of the housing.

8. The UV light viewing apparatus according to claim 1, further comprising an eyepiece disposed over the opening in the roof of the housing.

9. The UV light viewing apparatus according to claim 8, further comprising a transparent, UV-A filtering window extending across the opening in the roof.

10. The UV light viewing apparatus according to claim 1, wherein the housing includes a frame and a cover disposed over the frame.

11. An ultraviolet (UV) light viewing apparatus, comprising:
a housing configured to block ambient and UV light, the housing having a floor, a roof, and a sidewall cooperating to define an interior sample test-receiving volume enclosed along a rear end of the housing and portions of opposing first and second sides of the housing to thereby define an access opening providing access to the interior sample test-receiving volume that extends along a front end of the housing and portions of opposing first and second sides of the housing;
at least one UV light source configured to illuminate the interior sample test-receiving volume;
an opening defined within the roof of the housing, the opening configured to enable visualization into the interior sample test-receiving volume; and
a curtain engaged with the housing and configured to block ambient and UV light, the curtain including a front portion extending along the front end of the housing and first and second side portions that extend along respective first and second portions of the opposing first and second sides of the housing not occupied by the sidewall such that the curtain substantially covers the access opening.

12. The UV light viewing apparatus according to claim 11, wherein the curtain includes a plurality of flexible, vertically-extending curtain strips that are movable relative to one another to enable access to the interior sample test-receiving volume through the access opening.

13. The UV light viewing apparatus according to claim 11, wherein the curtain is removably engagable with the housing.

14. The UV light viewing apparatus according to claim 13, wherein the curtain includes a frame and a curtain body supported by and depending from the frame, the frame of the curtain releasably magnetically engagable with the housing.

15. The UV light viewing apparatus according to claim 11, wherein a body of the curtain is made of neoprene.

16. The UV light viewing apparatus according to claim 11, wherein the at least one UV light source includes at least one array of LED excitation lights mounted on an interior surface of the housing.

17. The UV light viewing apparatus according to claim 16, wherein the at least one array of LED excitation lights mounted on the interior surface of the housing includes a first array of LED excitation lights mounted along the first side of the housing, a second array of LED excitation lights mounted along the second side of the housing, a third array of LED excitation lights mounted along the rear end of the housing, and a fourth array of LED excitation lights mounted along the front end of the housing.

18. The UV light viewing apparatus according to claim 11, further comprising an eyepiece disposed over the opening in the roof of the housing.

19. The UV light viewing apparatus according to claim 18, further comprising a transparent, UV-A filtering window extending across the opening in the roof.

20. The UV light viewing apparatus according to claim 11, wherein the housing includes a frame and a cover disposed over the frame.
